(19) United States
(12) Patent Application Publication
(10) Pub. No.: US 2021/0311541 A1
(43) Pub. Date: Oct. 7, 2021

(54) CONTROLLER FOR TOUCHLESS KEYPAD

(71) Applicant: WIKEY CLOUD SOLUTIONS LTD., Rishon LeZion (IL)

(72) Inventor: Ofir Paz, Rishon LeZion (IL)

(21) Appl. No.: 17/219,958

(22) Filed: Apr. 1, 2021

Related U.S. Application Data
(60) Provisional application No. 63/003,938, filed on Apr. 2, 2020.

(51) Int. Cl. G06F 3/01

(52) U.S. Cl. CPC G06F 3/01

(57) ABSTRACT

A method for operating a machine having a Central Processing Unit (CPU) operable to control response of the machine to input manually made on a native keypad of the machine, the method comprising: bypassing the native keypad including: receiving inputted data, corresponding to keystrokes on the native keypad, from a computerized device; converting the inputted data into native keypad signals recognizable by the CPU of the machine; and, transmitting the native keypad signals to the CPU of the machine.

### RELATED APPLICATIONS

The present application claims benefit under 35 USC § 119(e) of U.S. Provisional Application 63/003,938 filed on Apr. 2, 2020, the disclosure of which is incorporated in its entirety herein.

### TECHNICAL FIELD

Embodiments of the disclosure relate to devices which convert touch operated devices to touchless operated devices.

### BACKGROUND

Many devices in today's world use touch operated mechanisms, such as keypads and fingerprint access devices. For example, automatic teller machines (ATMs), and access control systems, such as building entries, doors, elevators, and automobiles, all employ keypads. These keypads typically activate based on the acceptance of a code, such as a personal identification number (PIN), or other identifier, which is input to the keypad by physically contacting and touching the requisite keys. These PINs and identifiers are insecure and easily obtained by imposters. Additionally, keypads are unsanitary and transmit disease, as they must be physically interacted with, by contact, including touching, to activate the keys. This contact may result in the transfer of germs, pathogens or contaminants, left on the keys by previous users, which are transferred to the present user during contact with the keypad keys, while inputting a code or the like. These transferred germs, pathogens or contaminants may include the deadly Corona Virus, such as COVID-19.

### SUMMARY

An aspect of an embodiment of the disclosure relates to providing a controller in a machine for rendering “touchless”, a native keypad of the machine by which the machine is conventionally operable, allowing for keystrokes normally made by touching the native keypad or keyboard to be made remotely. The controller sets up a communication link via the controller between a user communication device, such as a smart phone, and a CPU of the machine. As part of the communication link the user device receives a copy of a keypad or other data entry mechanism, usable as a surrogate of the machine's native keypad, on the display screen of the device. The user enters the requisite data onto the user keypad on his device. The data is transmitted to the controller, which converts the received data in signals recognized as keypad control signals by the CPU of the machine. As a result, the need for user physical interaction with the actual keypad of the machine is eliminated, as the actual keypad is bypassed, and replaced in favor of the surrogate keypad, presented on the display screen of the device, by a chat application or the like. The controller does not require any additional software adaptations, and does not require any access codes, which are open to hacking.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Unless otherwise indicated, the word “or” in the description and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

FIG. 1A schematically shows an exemplary controller, in accordance with an embodiment of the disclosure;

FIG. 1B schematically shows the controller of FIG. 1A in use on a machine with a keypad, in accordance with an embodiment of the disclosure;

FIG. 2 schematically shows an exemplary environment in which embodiments of a controller is operating in accordance with an embodiment of the disclosure;

FIG. 3 schematically shows the controller of FIG. 1A in use with an automated teller machine (ATM) operable by a keypad in accordance with an embodiment of the disclosure;

FIG. 4 schematically shows the controller of FIG. 1A in use with an access control system, operable by a keypad in accordance with an embodiment of the disclosure; and

FIG. 5 schematically shows the controller of FIG. 1A performing an administrative function in accordance with an embodiment of the disclosure.

### DETAILED DESCRIPTION

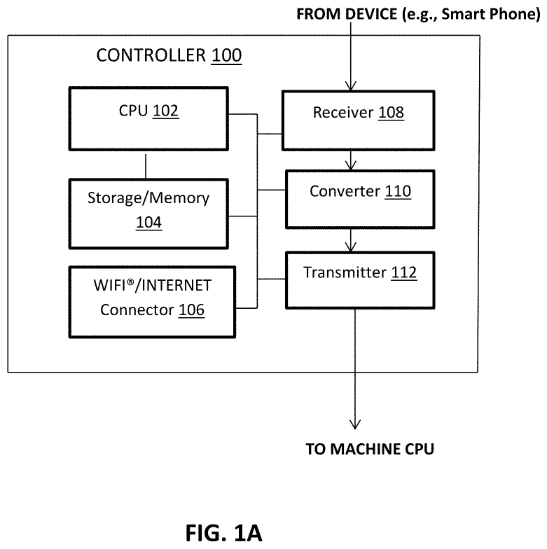

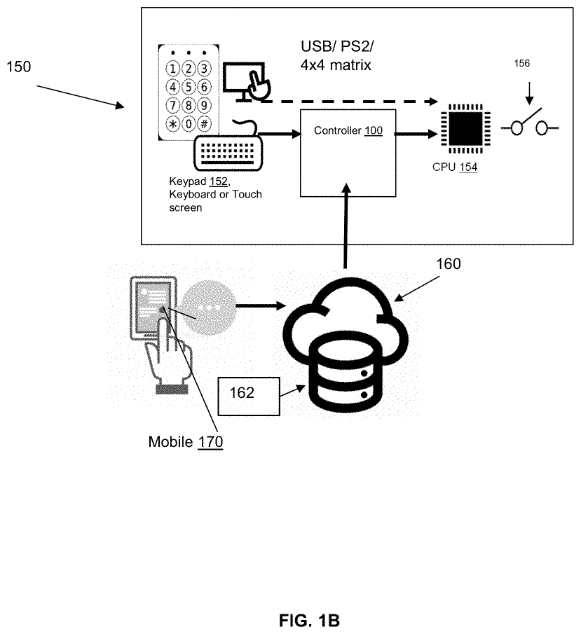

FIG. 1A schematically shows an exemplary controller 100 in accordance with an embodiment of the disclosure, which may be used in conjunction with a native keypad, fingerprint access device, or the like, to make the keypad or fingerprint access device (collectively referred to as a “native keypad”) operate in a touchless manner, so that the user may avoid any physical contact therewith. The controller 100 includes one or more processors, such as a central processing unit (CPU) 102, which links to storage/memory 104. The CPU 102 links to a WIFI®/Internet connector 106, as well as, a receiver 108, a converter 110, and a transmitter 112. While the aforementioned components (102, 104, 106, 108, 110 and 112), are the most germane to the discussion of controller 100, other components are permissible. “Linked” as used herein includes both wire or wireless links, for communication, wired and/or wireless, between the aforementioned components (102, 104, 106, 108, 110 and 112), either directly or indirectly.

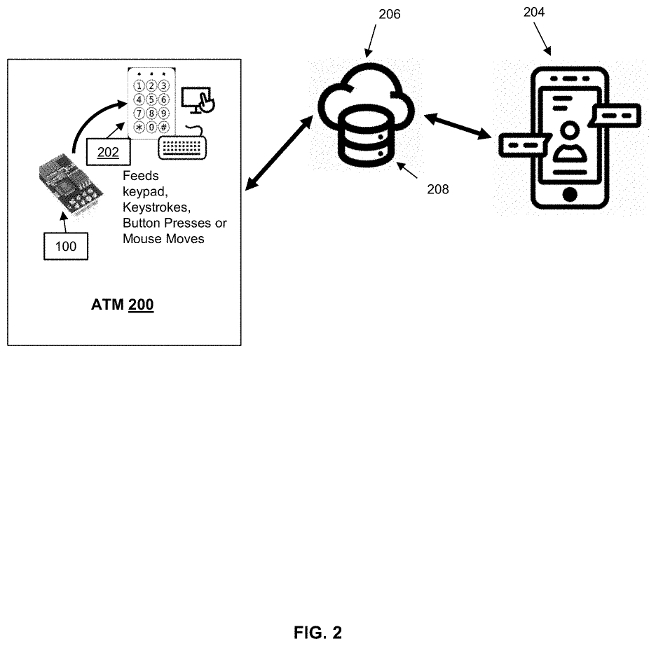

The CPU 102 is formed of one or more processors, including hardware processors, and performs processes of the disclosed subject matter, including touchlessly operating a keypad, coordinating the chat or other application (e.g., WhatsApp, Telegraph, Facebook Messenger) through which the user inputs data into the device. The device acts as a remote surrogate keypad, as shown, for example, in FIGS. 2-4, and detailed below. For example, the processors of the CPU 102 may include x86 Processors from AMD (Advanced Micro Devices) and Intel, Xenon® and Pentium® processors from Intel, as well as any combinations thereof.

The storage/memory 104 stores machine-executable instructions executed by the CPU 102 for performing the processes and methods of the disclosed subject matter. The storage/memory 154, for example, also provides temporary storage.

The WIFI®/internet connector 106 provides network connections for the controller 100. The connector 106 includes physical connections to the native keypad or supporting machine, which facilitate the network connection, the physical connections being by one or more of: pins, a PS/2 connection or a universal serial bus (USB) connection. The aforementioned physical connections provide for communications between controller 100 and the native keypad, or supporting machine, e.g., an ATM (the supporting machine including internal connections to the native keypad). Connector 106 links the CPU 102 to back end servers (162 of FIG. 1B). The back end servers assist the controller 100 with injecting keystrokes and mouse moves, button presses, contacts, swipes, voice and text entries, and the like, received from a remote device, to the CPU of the supporting machine.

The receiver 108 receives signals over the WIFI® Internet, the signals, for example, representing keystrokes, mouse moves, button presses, contacts, swipes, voice and text entries, and the like, in the case of a push button surrogate keypad or screen display surrogate keypad, or a contact in the case of a fingerprint reader. The signals are generated by secured applications on a user device. The secured applications include, for example, WhatsApp, Telegraph, and Facebook Messenger. The received signals may originate as one or more of touch commands, text commands and voice commands, inputted by the user into his device. The device includes, for example, a computerized device, such as a smart phone, tablet computer, or other computer, with network, e.g., Internet, access.

The converter 110 comprises, for example, executable instructions and/or data programmed onto a processor or the like, for converting the received signals, for example, representative of surrogate keypad keystrokes, to operational keypad signals for the CPU of the requisite machine, which are recognized by the CPU of the requisite machine as keypad keystrokes, button depressions and the like. The executable instructions may include open source software, such as “ESP Easy”, NODE JS, JINT—Javascript interpreter.

The transmitter 112, transmits the signals produced by the converter 110 for keypad operations, to the CPU of the requisite machine, which processes the keypad signals, for touchless machine operation, to bypass the native keypad.

FIG. 1B schematically shows the controller 100 installed in a machine 150, e.g., a computer, which accepts input from keypads, mice, touchscreens, text entry and the like, represented by element number 152. The controller 100, via pins (4×4 matrix), a PS/2, or a USB connection, connects to the machine 150, so as to be in wired or wireless communication with the keypad/mouse/touchscreen/text entry 152 and the CPU 154 (and an optional access control relay 156) of the machine 150. The machine 150 communicates with a network 160, such as the Internet. The back end server 162, for operating the controller 100 is also connected to the network 160. A device 170, such as a smart phone, with internet access, communicates with the machine 150 and the controller 100, through the network 160, to touchlessly control the keypad/mouse/touchscreen/text entry 152. Upon receiving signals from the device 170 of emulated keystrokes and mouse moves, as well as input from touch or text entry, the controller 100, via the back end server 162, converts the signals into operational keystrokes, mouse moves, touch or text entries, readable by the CPU 154, for operating the machine 150, so as to bypass the keypad/mouse/touchscreen/text entry 152 of the machine 150, the bypass shown by the broken line arrow.

FIG. 2 schematically shows an example environment in which the controller 100 operates. The controller 100 is installed on a machine 200. The machine 200, may be an ATM, with a keypad (native keypad) 202, for example, either a push button keypad or a screen display keypad. A device 204 (e.g., a computerized device), such as a smart phone with network, e.g., Internet access, is in electronic and/or data communication with the machine 200, through a network 206, such as the Internet. The controller 100 also connects to its backend controlling server 208, via the Internet.

Using device 204, the user provides keystrokes for operating the keypad 202 of the ATM (machine 200), through one or more of touch, text and/or voice commands input to device 204. For example, the device 204 may have installed thereon a standard chat application (APP), which injects chat keys to the display screen (e.g., touchscreen) of the device 204, the chat keys corresponding to native keypad buttons, to receive human keystrokes at the display screen. The controller 100 converts the received signals from the device 204, which correspond to keystrokes normally made by manual operation of the native keypad 202, into signals recognized as keypad control signals by the CPU of the ATM 200, whereby the ATM 200 is operated touchlessly, as the keypad 202 has been bypassed.

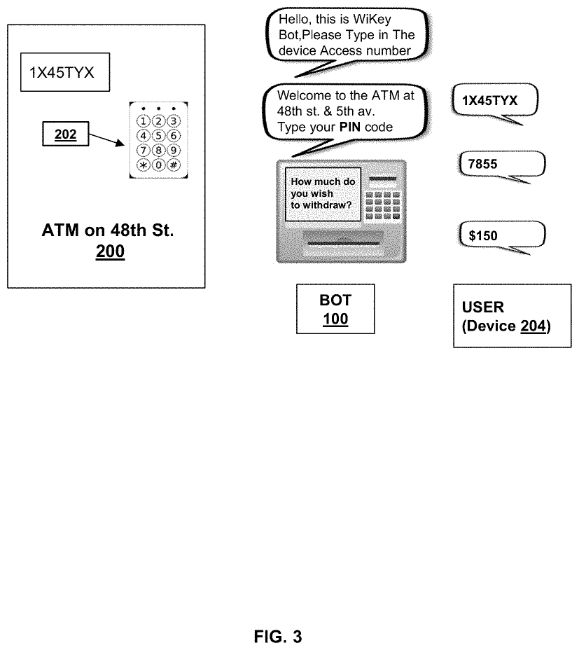

FIG. 3 schematically shows an example of the controller 100 (e.g. operating as a BOT) in use with an ATM machine 200 to bypass native keypad 202 of the ATM machine 200. The user communicates with the ATM machine 200 through his smartphone 204, via the Internet, for example in a chat format. Should the chat be a voice chat, voice recognition software or a voice recognition APP has been installed on the device 204.

To access the ATM 200, the user, via his WIFI/Internet connected smartphone 204, inputs the machine access code, “1X45TYX”, which is visible on the ATM 200, either via text or voice. This input is received by the controller 100, which converts the input into keystroke/keypad signals recognized by the ATM 200 CPU. With the machine access code accepted by the ATM 200 CPU, the ATM 200 CPU causes the chat application on device 204 to prompt the user to enter his PIN code. The user inputs his pin code, “7855” to the display (e.g., a surrogate keyboard/keypad of the device 204) associated with the chat application, and the input is sent to the controller 100, which converts the inputted pin code into keystroke/keypad signals recognized by the ATM 200 CPU, and transmits these signals to the ATM 200 CPU. Should the ATM 200 CPU authenticate the PIN code, the ATM 200 CPU causes the chat application to prompt the user to enter the withdrawal amount desired. The user enters, via the device 204, the amount desired, $150, which is sent to the controller 100, converted into keystroke/keypad signals recognized by the ATM 200 CPU, which causes the machine (ATM 200) to issue $150 to the user, ether manually, as physical money, or electronically, onto the device, 204, e.g., smartphone.

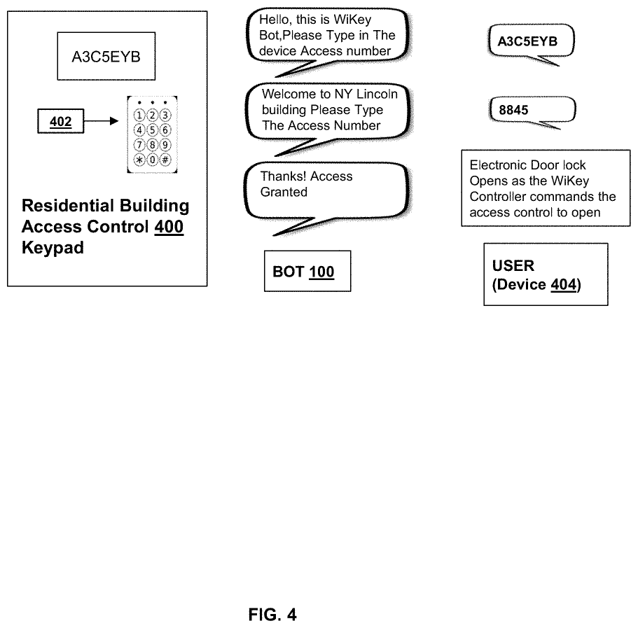

FIG. 4 schematically shows an example of the controller 100 (e.g. operating as a BOT) in use with an access control system 400, which includes a computer, and access control is operable by a keypad 402. The user communicates with the system through his device 404, via the Internet, for example in a chat format. Should the chat be a voice chat, voice recognition software or a voice recognition APP has been installed on the device 404.

To access the system 400, the user, via his WIFI/Internet connected smartphone 404 inputs the machine access code, “A3C5EYB”, which is visibly present on the system 400, either via text or voice. The controller 100 converts the signals associated with the machine access code into signals representative of keystrokes on the keypad for the access code, recognizable as such by the CPU of the system 400. With the machine access code accepted by the system 400, the system 400 prompts the user, via the chat application on device 404, to enter his building access code. The user inputs building access code, “8845” to the display associated with the chat application on his device 404, and the input is sent to the controller 100. The controller 100 converts the input to keystroke/keypad signals recognizable by the CPU of the system 400. The system 400 authenticates the building access code, and transmits to the device 404, that access has been granted, and the electronic door lock for the door opens.

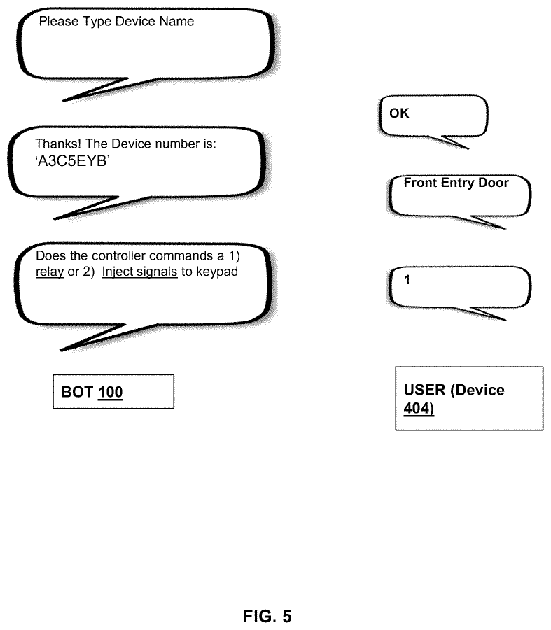

FIG. 5 schematically shows the controller 100 (e.g. operating as a BOT) performing an administrative function. Here, through a chat application, such as WhatsApp, the controller 100 is registering a new machine, for example an access control system, such as the access control 400 system of FIG. 4, to be operated remotely by a user's device, 404, e.g., smart phone, so as to bypass the actual keypad 402 of the access control system 400.

While the controller 100 has been described above for machines using keypads, the controller 100 may also be used with other machines using touch devices, such as fingerprint and palm print detectors.

Embodiments of the disclosed subject matter are directed to a method for touchlessly operating a machine having a Central Processing Unit (CPU) operable to control response of the machine to input manually made on a native keypad of the machine. The method comprises bypassing the native keypad, which includes: receiving inputted data, corresponding to keystrokes on the native keypad, from a computerized device; converting the inputted data into native keypad signals recognizable by the CPU of the machine; and, transmitting the native keypad signals to the CPU of the machine.

Optionally, the method is such that the computerized device includes a surrogate keyboard, corresponding to the native keyboard, through which the received data is inputted. Optionally, the method is such that the native keypad signals include signals representative of keystrokes on the native keypad. Optionally, the method is such that the inputted data is from one or more of text commands, voice commands or touch commands. Optionally, the method is such that the inputted data includes signals generated by secured applications on the computerized device. Optionally, the method is such that the secured applications include chat applications. Optionally, the method is such that it additionally comprises: receiving an identifier from the computerized device to cause the bypassing of the native keyboard. Optionally, the method is such that the identifier includes a predetermined code. Optionally, the method is such that the bypassing of the native keyboard includes the computerized device in communication with the CPU of the machine. Optionally, the method is such that the computerized device includes at least one of a smart phone, tablet computer, or device with network access.

Embodiments of the disclosed subject matter are directed to a controller for touchlessly operating a machine, by bypassing the native keyboard of the machine, and facilitating communication between a computerized device and the CPU of the machine. The controller comprises: a receiver for receiving inputted data, corresponding to keystrokes on the native keypad, from the computerized device; a processor in communication with the receiver, the processor including a converter programmed to convert the inputted data into native keypad signals recognizable by the CPU of the machine; and, a transmitter in communication with the processor, the transmitter for transmitting the native keypad signals to the CPU of the machine.

Optionally, the native keypad signals include signals representative of keystrokes on the native keypad. Optionally, the inputted data is from one or more of text commands, voice commands or touch commands. Optionally, the inputted data includes signals generated by secured applications on the computerized device. Optionally, the secured applications include chat applications. Optionally, the receiver is configured for receiving an identifier from the computerized device, and responsive to the received identifier, the processor places is in communication with the computerized device and the CPU of the machine, such that the native keyboard of the machine is bypassed. Optionally, the identifier includes a predetermined code. Optionally, the computerized device includes at least one of a smart phone, tablet computer, or device with network access.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims.

1. A method for operating a machine having a Central Processing Unit (CPU) operable to control response of the machine to input manually made on a native keypad of the machine, the method comprising:
bypassing the native keypad including:
receiving inputted data, corresponding to keystrokes on the native keypad, from a computerized device;
converting the inputted data into native keypad signals recognizable by the CPU of the machine; and,
transmitting the native keypad signals to the CPU of the machine.

2. The method of claim 1, wherein the computerized device includes a surrogate keyboard, corresponding to the native keyboard, through which the received data is inputted.

3. The method of claim 1, wherein the native keypad signals include signals representative of keystrokes on the native keypad.

4. The method of claim 1, wherein the inputted data is from one or more of text commands, voice commands or touch commands.

5. The method of claim 1, wherein the inputted data includes signals generated by secured applications on the computerized device.

6. The method of claim 5, wherein the secured applications include chat applications.

7. The method of claim 1, additionally comprising: receiving an identifier from the computerized device to cause the bypassing of the native keyboard.

8. The method of claim 7, wherein the identifier includes a predetermined code.

9. The method of claim 1, wherein the bypassing of the native keyboard includes the computerized device in communication with the CPU of the machine.

10. The method of claim 9, wherein the computerized device includes at least one of a smart phone, tablet computer, or device with network access.

11. A controller for touchlessly operating a machine, by bypassing the native keyboard of the machine, and facilitating communication between a computerized device and the CPU of the machine, the controller comprising:
a receiver for receiving inputted data, corresponding to keystrokes on the native keypad, from the computerized device;
a processor in communication with the receiver, the processor including a converter programmed to convert the inputted data into native keypad signals recognizable by the CPU of the machine; and,
a transmitter in communication with the processor, the transmitter for transmitting the native keypad signals to the CPU of the machine.

12. The controller of claim 11, wherein the native keypad signals include signals representative of keystrokes on the native keypad.

13. The controller of claim 11, wherein the inputted data is from one or more of text commands, voice commands or touch commands.

14. The controller of claim 11, wherein the inputted data includes signals generated by secured applications on the computerized device.

15. The controller of claim 14, wherein the secured applications include chat applications.

16. The controller of claim 11, wherein the receiver is configured for receiving an identifier from the computerized device, and responsive to the received identifier, the processor places is in communication with the computerized device and the CPU of the machine, such that the native keyboard of the machine is bypassed.

17. The controller of claim 16, wherein the identifier includes a predetermined code.

18. The controller of claim 11, wherein the computerized device includes at least one of a smart phone, tablet computer, or device with network access.
